(19) United States
(12) Patent Application Publication
(10) Pub. No.: US 2026/0029861 A1
(43) Pub. Date: Jan. 29, 2026

(54) METHODS OF INPUT TO EXTENDED REALITY SYSTEMS

(71) Applicant: Chay Edry, Thornhill (CA)

(72) Inventor: Chay Edry, Thornhill (CA)

(21) Appl. No.: 19/267,492

(22) Filed: Jul. 11, 2025

Related U.S. Application Data
(60) Provisional application No. 63/675,269, filed on Jul. 25, 2024.

(51) Int. Cl. G06F 3/0354; G06F 3/0362; G06F 3/04815; G06F 3/16; G06T 19/00

(52) U.S. Cl. CPC G06F 3/03547; G06F 3/0362; G06F 3/04815; G06F 3/167; G06T 19/006

(57) ABSTRACT

The present disclosure is directed towards systems and methods for interacting with a computing device in a virtual, augmented, or mixed reality environment. The system comprises a ring input device worn on a user's middle phalange on the middle finger and may also comprise a tracker module for tracking index finger pointing. The ring input device has a touch-sensitive surface for receiving input from the user's thumb, without substantially bending the thumb. The computing device is operably coupled to both the ring input device and the tracker module and configured to receive input from both simultaneously and execute actions corresponding to the received inputs. The disclosure offers an intuitive and effective approach to interacting with computing devices in various environments.

### PRIORITY/RELATED APPLICATION

This application is based on U.S. Provisional Patent Application No. 63/675,269, filed Jul. 25, 2024, the contents of all of which are incorporated herein by reference in their entirety.

### BACKGROUND

The present disclosure is directed to the field of augmented reality, virtual reality, and mixed reality, collectively referred to as extended reality or XR, providing intuitive and immersive inputting systems and methods. Particularly, this disclosure is directed to methods and systems comprising a ring input device.

XR environments are designed to provide immersive or semi-immersive experiences to users by allowing for interaction with virtual elements or real-world elements enhanced with virtual features. A critical aspect of these environments is the user interface, which allows users to interact with the XR environment.

Current interaction methods in XR often involve handheld controllers, glove-like devices, or trackers that are configured to detect, for example, a user's hand movements for specified gestures that translate into commands. However, these methods often require a steep learning curve as users must familiarize themselves with the set of possible gestures and can be error prone. Additionally, these interaction methods may not provide a natural or intuitive user experience, thereby limiting the user's immersion in XR.

Another current interaction method in XR includes the use of gaze tracking, where the direction of the user's gaze controls a cursor or other interactive element in the XR. Typically, gaze tracking is used in conjunction with gesturing for selection, with one commonly employed gesture being the touching of the thumb to the tip of the index finger. However, this and other gestures currently lack seamless transitioning between XR environment and other user actions. For example, while engaged in XR, a user might pause to make coffee, blow their nose, cough, stretch, take a phone call, or perform other everyday tasks such as typing on a keyboard, support their head while reading, or picking up objects, inadvertently creating input in the XR environment. This can lead to frustration and inefficiency for the user, as unintended inputs disrupt workflow and often require additional input to undo or correct the error. The present disclosure addresses this issue by enabling users to stay connected to the XR environment and provide input only when needed, thereby ensuring that interactions are deliberate and reducing the likelihood of accidental activation during everyday activities. In other words, the present disclosure offers an input solution that is both intuitive and comfortable yet ensures that input actions are performed intentionally.

Another interaction method in XR includes voice commands. While voice commands free the user's hands and provide a more natural form of interaction, they may not be suitable for all environments or scenarios, for example, in noisy environments. The voice command system alone also lacks tactile feedback for the user and may not provide the precision required for certain interactions within the XR environment.

Consequently, there is a need for a simplistic, accurate, intuitive, and immersive XR interaction method, especially one that may be used in conjunction with a plurality of interaction methods and systems. A method and system that is flexible and compatible with a plurality of XR environments and scenarios, especially as XR technology is a developing field that is constantly improving. The ideal interaction method should be intuitive, natural, precise, and comfortable, allowing the user to interact with the XR for extended periods with no initial learning curve and no unintentional input. It should also be adaptable to various environments and scenarios, and not limit the user's ability to explore the XR visually or audibly. Furthermore, the interaction method should allow for simultaneous input from multiple sources, increasing the range and complexity of possible interactions within the XR. The interaction method disclosed herein facilitates the optimization of the XR field and harnesses all the associated advantages.

### SUMMARY

Disclosed, in an exemplary implementation, is a system and method to interact with a computing device. Specifically provided is an exemplary implementation of a system for interacting with a computing device, which comprises a ring input device. In exemplary implementations the system comprises the ring input device, a tracker module, and a virtual reality, an augmented reality, or a mixed reality environment, collectively referred to as an extended reality environment or XR environment.

In another exemplary implementation provided herein is a system for interacting with a computing device comprising: a ring input device worn on a user's middle phalange, the ring input device having a touch-sensitive surface for receiving input from the user's thumb, without substantially bending the thumb; the computing device operable coupled to the ring input device, the computing device further comprising at least one processor in communication with a non-transitory memory device, storing thereon a set of executable instructions configured when executed by the at least one processor to execute actions corresponding to the input received from the ring input device; and a XR environment operationally configured to interact with the computing device and execute actions corresponding to both ring input and a tracker module operationally configured to track index finger pointing.

Implementations may comprise one or more of the following features. For example, the ring input device can be operationally configured to allow freedom of movement of the user's index finger. The ring input device may be operably configured so that the interphalangeal joint of the thumb does not bend more than 45° from its natural position while interacting with the touch-sensitive surface. The ring input device may be operably coupled to the middle phalange of the user's middle finger. The ring input device may have a ring body that is at least partially made of elastomeric material. For example, the ring input device may be made of about 5% to about 80% elastomeric material. The ring body may further comprise an opening such that the ring is generally C-shaped. The touch-sensitive surface of the ring input device may be arranged on the interphalangeal joint to easily receive input from the user's thumb. At least a portion of the ring input device may be composed of elastomeric material to allow releasable coupling of the ring input device to a user's interphalangeal joint. The ring input device may be comprised of at least one elastomeric portion, operable as a hinge or live hinge.

The computing device may be configured to simultaneously receive input from both the ring input device, and the tracker module. The tracker module may be: an image capture module, an optical sensor, an inertial measurement unit, an electromagnetic tracking module, part of a XR headset, or a combination comprising one or more of the foregoing. The ring input device, the computing device, the XR environment, and the tracker module thereof, may be wirelessly connected. Furthermore, the XR environment may be integrated with the computing device. The set of executable instructions may be further configured, when executed by the at least one processor, to cause the computing device to execute actions comprising at least one of: scrolling, zooming, selecting, grabbing, rotating, firing shots in a first-person shooter game, manipulating 3D content, initiating a voice input interaction, interacting with virtual user interface (UI) elements, or any combination thereof. Each executable action may correspond to the input received from the ring input device, tracker module, or a combination thereof. The tracker module may be integrated with the XR environment. The tracker module may be further configured for gaze tracking

In further implementations, the system may comprise an additional ring input device and tracker module in communication with the computing device. For example, the set of executable instructions may be further configured, when executed by the at least one processor, to cause the computing device to execute additional executable actions corresponding to input from the first ring input device, the first tracker module, the second ring input device, the second tracker module, or any combination thereof.

In other aspects, the touch-sensitive surface of the ring input device may comprise a plurality of components in a plurality of arrangements. For example, the touch-sensitive surface of the ring input device may comprise at least one of: a touchscreen, a scroll wheel, a button, or a combination thereof. Furthermore, the touch-sensitive surface of the ring may be depressed relative to the ring input device to prevent unintentional input. Furthermore, the touch-sensitive surface of the ring may be arranged on the dorsal and ventral sides of the ring input device. For example, in implementations with a live hinge, the touch sensitive surface components may be mounted on the dorsal and ventral sides of the ring input device, wherein the ring input device is configured to be open and closed.

The ring input device may also be configured to provide tactile feedback to the user upon receiving the input. The system may also comprise a power module configured to power on or off the ring input device based on its configuration. The power module may comprise a power-saving feature that puts the ring input device into a standby mode when not in use.

The touch-sensitive surface of the ring input device may also comprise a designated button to initiate voice-based interaction. The voice-based interaction may be initiated by a press and hold user input or a double click user input on the designated button. The voice-based interaction may be operable to send an input voice-based user prompt to a large language model or artificial intelligence (AI) module. The large language model or AI module may be operable coupled to the computing device and configured to execute a corresponding executable function corresponding to the voice-based user prompt.

Furthermore, in an exemplary implementation provided herein is a method of interacting with a computing device using a ring input device, the method comprising: wearing the ring input device on a user's middle phalange; establishing a connection between the ring input device and the computing device; receiving input from the user's thumb on a touch-sensitive surface disposed on the ring input device without substantially bending the thumb; and transmitting the received input to the computing device for execution of corresponding actions.

Implementations of the method may comprise one or more of the following features. The method may further comprise a tracker module operationally configured to track the movement of at least one of the user's fingers and using the tracked finger movement as additional input for the computing device. The method may further comprise the ring input device being arranged on the middle phalange of a user's middle finger, and the tracked finger being a user's index finger. The computing device may be configured to receive input from both the touch-sensitive interface of the ring input device and tracker module simultaneously. The tracked finger may have freedom of movement. The tracked finger may have freedom of movement in at least the dorsal direction, the ventral directions, a side direction, or combinations thereof. The tracked finger may have freedom of movement while the user's thumb interacts with the touch-sensitive surface. The tracked finger may have freedom of movement in the plane above the user's thumb interacting with the touch-sensitive surface of the ring input device. In further exemplary implementations the ring input device may have a ring body comprising an opening such that the ring input device is generally ‘C-shaped’. In further exemplary implementations the ring input device may have a ring body comprising at least a portion of elastomeric material. In further exemplary implementations the ring input device may have a ring body comprising an elastomeric live hinge. In additional implementations the ring input device may be transitioned from a closed configuration to an open configuration.

The method where the tracker module and computing device may be integrated, and further comprising an augmented reality, a virtual reality, or a mixed reality environment (XR) operably coupled thereof. The method wherein the received input from the ring input device and tracker module may correspond to executable actions. Wherein the executable actions may comprise at least one of: scrolling, clicking, selecting, grabbing, rotating, moving a cursor, zooming, firing shots in a first-person shooter game, reloading in a first-person shooter game, manipulating 3-dimensional content, interacting with virtual UI elements, interacting with audio elements, initiating a voice-interaction, or any combination thereof. Furthermore, the tracker module may comprise at least one of: an image capture module with cameras, optical sensors, inertial measurement units, electromagnetic tracking, or a combination thereof. The tracker module may be further configured for gaze tracking.

The method wherein manipulating 3-dimensional content may comprise at least one of: resizing, shaping, sculpting, repositioning, rotating, animating, grouping, duplicating, or combinations thereof. The method may further comprise tactile feedback to the user upon receiving input. The method may further comprise an additional ring input device and tracker module operably coupled to the computing device. The method may comprise additional executable actions corresponding to input from the first ring input device, the first tracker module, the second ring input device, the second tracker module, and any combination thereof. The method may comprise additional operably coupled systems. For example, the method may further comprise at least an operable coupled: microphone, speaker, AI module, processor, another computing device, additional sensors, additional XR components, or combinations thereof.

Another exemplary implementation provided herein is a method for inputting distinct executable actions on the same hand of a user, the method implemented in a system comprising: at least one ring input device configured to be worn on the user's middle phalange and to receive input from the user's thumb on a touch-sensitive surface disposed on the ring input device, at least one tracker module configured to at least receive input from the user's index finger, at least one computing device, and an augmented reality, a virtual reality, or a mixed reality (XR) environment, operably connected thereof, and operably configured to receive the input and execute corresponding actions, the method comprising: inputting an executable action by the thumb interacting with the touch-sensitive surface, or the index finger interacting with the tracker module, or combinations thereof; receiving input from the ring input device, the tracker module, or combinations thereof; executing a corresponding action on the at least one computing device, or XR environment, or combinations thereof.

Exemplary implementations of the method may comprise one or more of the following features. The method wherein the ring input device may be operationally configured to be worn on the middle phalange of the user's middle finger. The method wherein the tracker module may track the user's index finger pointing and the index finger has freedom of movement. The index finger may have freedom of movement during the thumb and touch-sensitive surface interaction. The method wherein the computing device may receive input from the ring input device and tracker module simultaneously and in combination. The method wherein the computing device or XR environment may executes corresponding actions simultaneously. The method wherein corresponding actions may comprise at least one of: scrolling, clicking, selecting, moving a cursor, zooming, firing shots in a first-person shooter game, reloading in a first-person shooter game, manipulating 3-dimensional content, interacting with virtual UI elements, initiating a voice-interaction, or any combination thereof. The method may comprise additional inputs from a second hand's second ring input device and a second tracker module, wherein additional executable actions correspond to the additional inputs from the first ring input device, the first tracker module, the second ring input device, the second tracker module, or combinations thereof.

The method may further comprise additional inputs from a voice prompt or gaze tracking. The method may further comprise a ring input device with a touch-sensitive surface comprising a designated button to initiate voice-based interaction with an operably coupled microphone. The voice-based interaction may be initiated by a press and hold user input or a double click user input on the designated button. The voice-based interaction may be operable to send an input voice-based user prompt to an operably coupled: large language model (LLM), an artificial intelligence (AI) module, an Automatic Speech Recognition (ASR) engine, a Natural Language Processing (NLP) engine, a Natural Language Model (NLM), a conversational AI system, a voice assistant module, or combinations thereof. The AI module, for example, may be operable coupled to the computing device or XR system and configured to transmit a corresponding executable instruction corresponding to the voice-based user prompt. The operably coupled microphone may be operably coupled or embedded in an XR system, the computing device, or the ring input device. The operably coupled microphone may be activated by a pre-determined input on the designated button.

The method may be further implemented where the tracker module is operable to both finger tracking and gaze tracking. The method may be further implemented where the XR environment is integrated with the computing device and tracking module. The method may be further implemented with additional computing devices or XR systems. The XR system, tracker module, ring input device, and computing device may be connected wirelessly. The method may be implemented in a system where at least a portion of the ring input device is composed of elastomeric material. The method may be implemented in a system where the elastomeric material enables donning, doffing, and wearing of the ring input device. The method may be implemented in a system where the ring input device is composed of a ring body comprising an opening such that the ring input device is generally C-shaped.

The method may be implemented where the touch-sensitive surface of the ring input device may be at least one of: a touchscreen, a scroll wheel, a button, or a combination thereof in a plurality of arrangements. The method may be implemented where the touch-sensitive surface of the ring may be arranged on dorsal and ventral sides of the ring input device. The method may be implemented where the touch-sensitive surface of the ring may be arranged on either side of a live hinge of the ring input device. The method may be implemented where the touch-sensitive surface of the ring may be further arranged on distal and proximal end surfaces of the ring input device. The method may be implemented where the touch-sensitive surface of the ring is composed of a plurality of components arranged in a plurality of configurations.

The method may be implemented where the touch-sensitive surface of the ring input device may trigger a plurality of executable functions corresponding to the received input. The method may be implemented where a user's thumb may trigger an executable function by selecting, taping, sliding, swiping, holding, double-tapping, or combinations thereof on a portion or component of the touch-sensitive surface of the ring input device. The method may be implemented where the touch-sensitive surface has at least a portion or component configured for at least the executable function of: selecting, scrolling, zooming, initiating a Bluetooth connection, powering on, powering off, initiating a voice-based interaction, rotating, swiping, entering, shooting, holding, or combinations thereof.

The foregoing have been provided by way of general introduction and are not intended to limit the scope of the following claims. It is to be understood that the features described may each be implemented in combinations of embodiments and are not limited to an embodiment in which they are described. The described implementations, together with further advantages, will be best understood by reference to the following detailed description taken in conjunction with the accompanying drawings.

### BRIEF DESCRIPTION OF FIGURES

For a better understanding of the methods, and systems for interacting with a computing device using a ring input device, and with regard to the exemplary implementations thereof, reference is made to the accompanying examples and figures, in which:

FIG. 1A, illustrates a front perspective view of an exemplary implementation of a ring input device, while FIG. 1B shows the ring input device receiving input from a user's thumb;

FIG. 2, depicts an exemplary implementation of a user interacting with an XR environment with the ring input device;

FIG. 3, depicts another exemplary implementation of a user interacting with an XR environment;

FIG. 4, illustrates an exemplary implementation of a user and XR environment interaction with two ring input devices;

FIG. 5a-f, illustrates several implementations of the ring input device's touch-sensitive surface;

FIG. 6, illustrates an exemplary implementation of a method of using the ring input device and a tracker module to interact with a computing device;

FIG. 7, illustrates an implementation of a method to input a scroll command with the ring-input device;

FIG. 8, illustrates a method depicting an implementation of a general user action in FIG. 8A, and an implementation of user actions during an XR first-person shooter game is illustrated in FIG. 8B;

FIG. 9, illustrates an implementation of a user and virtual user interface interaction;

FIG. 10, illustrates a method of manipulating a 3-dimensional virtual object with ring and pointer input; and

FIG. 11, illustrates an implementation depicting dual ring usage.

### DETAILED DESCRIPTION

Provided herein are exemplary implementations of systems and methods to interact with a computing device in a virtual reality, an augmented reality, and a mixed reality environment, collectively referred to as extended reality or XR. In certain exemplary implementations, the disclosed method and ring-input device system provides increased accuracy, increased precision, and intuitive and comfortable use. User's may also benefit from a more immersive experience with direct tactile feedback and accurate tracking of index finger pointing. In these and other exemplary implementations and methods thereof, the disclosed method facilitates simultaneous thumb input and pointing input from a user's hand.

Additionally, the present disclosure provides a more complete understanding of implementations of use of a ring-shaped input device, referred to as simply the ring input device, and methods thereof that facilitate interactions with a computing device. The computing device as described below may or may not include an XR environment, but in exemplary implementations where an XR environment is included, it may range from at least operably connected to the computing device, to integrated completely with the computing device. Likewise for the tracking module, at a minimum, if not integrated with the XR environment or computing device, it is at least operably coupled to the XR environment and or computing device. These and other terms used in the present disclosure are further elaborated and defined in the following description for clarity and better understanding.

The accompanying drawings provides a more complete understanding of the input ring systems and methods. These figures (also referred to herein as “Fig.”) are merely schematic representations based on convenience and the case of demonstrating the present disclosure, and are, therefore, not intended to indicate relative size, scale and dimensions of the devices or components thereof, and/or to define or limit the scope of the exemplary implementations. Although specific terms are used in the following description for the sake of clarity, these terms are intended to refer only to the particular structure of the exemplary implementations selected for illustration in the drawings and are not intended to define or limit the scope of the disclosure. Changes and modifications may be made within the scope herein without departing from the spirit and scope thereof, and the present disclosure herein includes all such modifications. In the drawings and the following description below, it is to be understood that like numeric designations refer to components of like function. It is also to be understood that the use of dashed lines in the provided figures, such as depicted for the user and the user's hand, indicate elements that are not claimed. These elements are shown for illustrative purposes, to provide context, or to demonstrate a potential use, method, or environment for the present disclosure.

The present disclosure pertains to a system for interacting with a computing device, the system comprising a ring input device. In exemplary implementations, the system may also comprise a tracker module configured to track, for example, index finger pointing. In further exemplary implementations the system may further comprise a virtual reality, a mixed reality, or an augmented reality environment, collectively referred to as extended reality or XR. The components of the system may range from being operably coupled or connected to entirely integrated. In one type of exemplary implementation, the system for interacting with the computing device comprises: a ring input device configured to be worn on a user's middle phalange, the ring input device having a touch-sensitive surface for receiving input from the user's thumb; the computing device operably coupled to the ring input device the computing device further comprising at least one processor, in communication with a non-transitory memory device, storing thereon a set of executable instructions configured when executed by the at least one processor to execute actions corresponding to the input received from the ring input device; and a XR environment configured to interact with the computing device and execute actions corresponding to both ring input and a tracker module configured to track index finger pointing. The computing device and its components may be operably coupled to both the ring input device and the tracker module and be configured to receive input from both simultaneously and execute actions corresponding to the received inputs. For example the computing device may be operably coupled to both the ring input device and the tracker module, and may comprise at least one processor in communication with a non-transitory memory device, the memory device storing thereon a set of executable instructions configured, when executed by the at least one processor, to cause the computing device to receive input from both the ring input device and the tracker module simultaneously and to execute actions corresponding to the received inputs.

The XR environment may also be integrated with the computing device or merely operably coupled to the computing device and configured to execute actions corresponding to both ring input and tracker module input. The tracker module and ring input device may be operably coupled or integrated with the XR environment and may also comprise a processor in communication with a non-transitory memory device. The scope and diversity of possible system and communication architectures between the XR environment, computing device, ring input device, tracking module, and any additional systems should be apparent to one skilled in the art.

Furthermore, the ring input device may be configured to receive input from the user's thumb, without requiring substantial bending of the user's thumb. For example, the ring input device may be arranged on a user's middle phalange, and not require the thumb's interphalangeal joint to substantially bend while interacting with the ring input device. For example, the interphalangeal joint may not bend more than approximately 50°, 45°, 40°, 30°, 20°, or 15° from its natural or resting position. In certain implementations input may be achieved by movement of the metacarpophalangeal joint of the thumb. Or alternatively, combined movement of the thumb joints may achieve desired input without substantial bending from the thumbs natural position.

In exemplary implementations where the ring input device in the system is operably coupled to the middle phalange of a user's middle finger, the system allows for freedom of movement of the user's index finger. For example, the index finger may move uninhibited by the interaction of the thumb and the ring input-device. In other words, in this system and corresponding methods the index finger may maintain about its normal range of motion (ROM).

Furthermore, the tracker module may track without interference (e.g., visual blocking or movement interference) of the thumb and ring input-device interaction. This aspect may also increase the accuracy of the tracker module, for example, in an implementation of the system where the tracker module is integrated in a XR headset on a user, the user (and tracker module) will have a clear view of the index finger; the thumb and ring input-device interactions occurring on a lower plane. That is, the tracked finger may have freedom of movement in a plane above the thumb and ring input-device interaction. This feature also increases the intuitive use of the ring input system as pointing is a familiar and intuitive gesture. In another exemplary implementations, the middle finger may bend towards the ventral direction (towards the palm) to approach the thumb and enable comfortable thumb input on the ring input device while the uninhibited index finger may provide input to the tracking module.

The ring input device may be designed in various shapes and sizes to accommodate different user preferences and hand sizes. For example, the ring input device may be adjustable to fit various finger sizes or may be available in multiple fixed sizes. The ring input device may be made from various materials and coatings such as metals like titanium, plastics, alloys, or a combination thereof, and may also be composed of flexible and resilient elastomeric materials. The device may also feature different colors or designs to appeal to different user aesthetics. Furthermore, it may be releasable and operably coupled to a user's middle phalange with various mechanisms, e.g., frictionally coupled, adjustably coupled, etc. The ring input device may also be designed to be easily attached and detached from the user's finger. For example, the ring input device may feature a hinged design, a stretchable band, or a combination thereof. The ring input device may also be designed to be water-resistant or waterproof to accommodate different user needs and environments.

In exemplary implementations, the ring input device may be at least partially composed of elastomeric material, for example rubber, silicone, thermoplastic, or other elastomeric blends or composites. Or for example EPDM, Viton, VDF, HFP, TFE, or TPU. The ring input device may be about 5-85% elastomeric material in total. Additionally, the ring input device may have consecutive elastomeric portions arranged around the circumference of the device to enable stretching for donning, wearing, and doffing the ring input device. For example, the elastomeric portions may be disposed in one or more segments circumferentially around the ring body. These segments may be arranged consecutively or non-consecutively to form a discontinuous or continuous stretchable region. The inclusion of elastomeric material facilitates the expansion and contraction of the ring input device to accommodate donning (placement onto the finger), wearing, and doffing (removal from the finger) without requiring mechanical fasteners or hinges. This stretchability allows the ring input device to conform to varying middle phalange sizes, including size variations due to changes in temperature, movement, or physiological factors such as swelling. In certain embodiments, the elastomeric segments are strategically positioned to enhance circumferential flexibility, thereby providing distributed elasticity and improving comfort and fit during extended wear. The elastomeric composition also contributes to user safety, offering a breakaway mechanism in the event the ring becomes snagged or subjected to excessive force. The elastomeric material can enhance user comfort, reduce mechanical complexity, and improves the durability and wearability of the ring input device during repeated cycles of use.

In further exemplary implementations the ring input device may have a ring body comprising an opening such that the ring input device is generally ‘C-shaped’. The opening may facilitate comfortable donning, doffing, and wearing the ring input device. In other implementations, the ring input device may have a generally spiraled or coiled ring body, a generally open oval shaped ring body, or a generally open teardrop shaped ring body. In these and other implementations where the ring has an opening, e.g., spiral ring body or C-shaped ring body a user may twist on and off the ring to facilitate donning and doffing. In exemplary implementations, the ring input device will be generally ‘C-shaped’ and be substantially made of elastomeric material. For example, the C-shaped ring body may have elastomeric material arranged to function as a living hinge, that is, allowing opening and closing of the ring for comfortable and resilient donning, wearing, and doffing the ring input device. In exemplary implementations, the ring body may be 5-85% elastomeric material, with the ‘living hinge’ portion of the ring body having the same thickness or being thinner than the ring body. For such implementations, the hinge or ‘hinge portion’ may be arranged on a circumferential segment opposite the opening of the ring body. In other implementations just the hinge portion may be comprised of elastomeric material. Additional implementations may have the top/dorsal and bottom/ventral portions of the ‘C-shaped’ ring input device, the portions of the ring input device not opposite the opening, comprised of: elastomeric material, less elastomeric material when compared to the hinge portion, rigid material such as titanium, plastics or alloys, or combinations thereof. Furthermore, in exemplary implementations, the touch-sensitive surface of the ring body is arranged in a plurality of configurations such as on the dorsal and ventral portions of the ring input device, from the distal to proximal ends. In further implementations, the touch-sensitive surface of the ring body may be comprised of a plurality of components in a plurality of arrangements on the ring input devices outer surface. That is, the touch-sensitive surface may be arranged on two halves of the ring, at spaced pre-determined intervals, as a continuous surface, on either distal or proximal end surfaces, or combinations thereof.

In other aspects, the ring input device may have variable thickness around the diameter of the ring, e.g., a first portion or the ring body may be thinner or thicker relative to a second portion of the ring body. In exemplary implementations, portions of the ring body that may be relatively thinner when compared to the rest of the ring body may be arranged on a side portion of the ring, for example, when the ring input device is worn on the middle phalange of the middle finger, the thinner portion may face towards the user's index finger. In implementations with a C-shaped ring body, while the ring input device is worn on the middle phalange of the middle finger, the opening of the ring body may face the ring finger and a thinner portion of the ring body may also be the live hinge portion made of elastomeric material and may face towards the user's index finger. In other implementations a plurality of thicknesses, shapes, and arrangements of elastomeric material may compose the ring body.

The ring input device may be configured so that the interphalangeal joint of the thumb does not bend substantially, for example more than about 20°, from its natural position while interacting with the touch-sensitive surface. This feature enhances user comfort and prevents strain or discomfort during prolonged use, providing ergonomic benefits. The touch-sensitive surface may be made from various materials such as glass, plastic, or a combination thereof. The touch-sensitive surface may also be designed to provide different levels of sensitivity to accommodate different user preferences.

The tracker module in the system may utilize an image capture module, an optical sensor, an inertial measurement unit, an electromagnetic tracking, part of a XR headset, or a combination comprising one or more of the foregoing. This versatility allows the system to be used in a wide range of applications and environments. The tracker module may also receive additional inputs or track additional movements or fingers. For example, the tracker module may also gaze track, gesture track, etc.

The ring input device, the computing device, the XR, and tracker module thereof, are operably coupled, for example with a wireless connection, such as via Bluetooth technology. Additionally, the system may use various versions of Bluetooth technology or other wireless technologies such as Wi-Fi, near field communication (NFC), or a combination thereof. Exemplary implementations use a wireless connection as it allows for greater user mobility, but the system may also feature a wired connection option.

The computing device is configured to execute actions comprising at least one of: scrolling, selecting, firing shots in a first-person shooter game, reloading in a first-person shooter game, manipulating 3-dimensional content, interacting with virtual user interface (UI) elements, initiate a voice-based interaction, additional application-specific interactions or manipulations, or any combination thereof. The computing device may be a desktop computer, a laptop computer, a tablet computer, a smartphone, a smart TV, a game console, or any combination thereof. The computing device may also be equipped with various additional input and output devices such as a keyboard, a mouse, a monitor, speakers, projectors, or any combination thereof.

Each executable action or set of executable instructions corresponds to the input received from the ring input device and tracker module or a combination thereof. The system may support additional input methods such as gestures, voice commands, gaze tracking, or a combination thereof. The system may also be designed to support various output methods such as visual display, audio feedback, haptic feedback, or a combination thereof. The system may feature customizable settings and additional components for different user preferences and needs.

In an alternative implementation, the system will comprise the ring input device and an alternative tracker module configured for gaze tracking. For example, a user's gaze may control a curser movement and the ring input device may be used for clicking and scrolling input. Essentially, gaze tracking input may take the place of pointing input in additional implementations. Of course, one or both types of tracking may be used concurrently, or additional input methods may be used in complementary implementations.

In further implementations the system may comprise an additional ring input device and tracker module in communication with the computing device. This feature allows for greater user flexibility, immersion, and control as more input options and combinations are possible. For example, the system may further comprise additional executable actions corresponding to input from the first ring input device, the first tracker module, the second ring input device, the second tracker module, and any combination thereof. This feature allows for a wider range of interactive possibilities for the user. The additional executable actions may comprise advanced combinations such as dual-touch input, dual-pointing input, or a combination thereof. The additional executable actions may also include various game-specific actions, application-specific actions, or a combination thereof. Examples may include zooming or scaling by changing the distance between two index fingers, rotating 3-dimensional virtual objects or virtual user-interface elements by offsetting the angle between two index fingers, painting or drawing tools where one hand may control drawing or painting while the other hand supports the color pallet or an alternative artistic tool, dual wielding in a specified virtual game where a user may control an object in each hand such as a sword and a shield, two guns, etc. or additionally driving applications where for example one ring input turns the car and the other ring input controls the gear shift. These and other implementations of user interactions expounded upon further below illustrates the diversity of applications the methods and systems of the present disclosure may be applied to, in dual ring or single ring form, whether entertainment, educational, training, creative, creation, navigation, presentation, professional, or other objectives are desired. For example, a surgeon may use one hand to hold, orient, or rotate a target site while another hand may wield a virtual surgical tool.

The touch-sensitive surface of the ring input device itself may comprise at least one of: a touchscreen, a touch sensor, a scroll wheel, a button, a ring spinner, or a combination thereof. The touch-sensitive surface may provide a wide range of input possibilities for the user, supporting various inputs such as tapping, clicking, swiping, holding, selecting, scrolling, or a combination thereof. The scroll wheel or touch pad may support various scrolling actions such as scrolling up, scrolling down, scrolling left, scrolling right, or a combination thereof. Each feature of the touch-sensitive surface may be configured to be clickable and may support various pressing actions such as single press, double press, long press, or a combination thereof.

Additionally, the touch-sensitive surface may be comprised of combinations of buttons, touchscreens, wheels, etc. with designated or pre-determined functions upon specific user inputs. In exemplary implementations, the pre-determined function may correlate to a corresponding executable actions. e.g., a scroll wheel may be designated for scrolling, a button may be designated to initiate voice-based interaction upon press and hold input or a double click may initiate prompt recording, etc.

In additional exemplary implementations, the touch-sensitive surface of the ring input device may comprise a button designated for voice-based interaction with a large language model or artificial intelligence system. The button may be arranged in a plurality of configurations in the ring input device, for example near a portion on the distal end of the middle phalange. To initiate a voice interaction, the designated button may be pressed and held to initiate audio recording, and upon release the audio recording may be transmitted as an AI prompt. For example, the ring input device operably coupled to a tracker module that is a XR headset with an embedded microphone may be configured, upon initiating a voice interaction, to send or transmit a recorded prompt to an AI module or similar module operably coupled to the computing device for processing of a corresponding executable function and or transmission of an executable instruction. Other implementations may comprise a microphone embedded in the ring input device itself, or may comprise an operably coupled microphones, e.g., an external microphone operably coupled to the computing device, embedded in the computing device, operably coupled to a XR headset, embedded in the XR headset or other tracker module, operably coupled to the XR headset and computing device, or combinations thereof.

In other implementations, a double click on the designated button of the ring input device may initiate recording, and release of the second-click may end the recording and submit the prompt. The designated AI button or voice-based interaction button may be in addition to a plurality of input types and surfaces comprised by the touch-sensitive surface. For example, a scroll wheel designated for scrolling, a button designated for selecting, a button designated for power on/off or standby, a button designated for Bluetooth pairing, a touchscreen that may receive different types of swiping, tapping etc. The touch-sensitive surface may also have a plurality of arrangements on the ring body, for example on the outward dorsal and ventral side of the ring while wearing, as well as the side surfaces of the ring on the distal and proximal ends. Those skilled in the art may appreciate the full scope of possible configurations of the touch-sensitive surface and the arrangements thereof.

For example, the touch sensitive surface of the ring may have a continuous surface area or may have a plurality of components with a plurality of arrangements on the outer surfaces and distal and proximal side surfaces of the ring. That is, there may be sections of the touch-sensitive surface on the outer surface and or side surfaces of the ring, e.g., ventral surface, dorsal surface, right surface, left surface, distal side surface, proximal side surface, or combinations thereof.

The touch-sensitive surface of the ring may also be depressed relative to the ring input device's body to prevent unintentional input. This feature may enhance user control and reduce the likelihood of errors. The depression may be designed in various shapes and sizes to accommodate different user preferences and hand sizes. For example, the depression may be circular, rectangular, or a combination thereof. The depression may also be designed to provide different levels of depth to accommodate different user preferences.

In exemplary implementations, the ring input device may be configured to provide tactile feedback to the user upon receiving the input. This feature enhances user interaction, reduces error, and provides a more immersive experience. The tactile feedback may be physical, as in implementations where the touch-sensitive surface comprises clickable buttons or a physical/mechanical scroll wheel. Alternatively, the tactile feedback may be provided by various types of vibrations, pulses, simulating clicking, or a combination thereof. The tactile feedback may also be customizable to accommodate different user preferences. For example, the user may adjust the intensity, duration, or pattern of the tactile feedback.

In exemplary implementations, the touch-sensitive surface of the ring may recognize as distinct inputs swiping in the distal direction, proximal direction, either side direction, clicking at a pre-determined location, double tapping at a pre-determined location, press and hold at a pre-determined location, swiping and then clicking at a predetermined location, and combinations thereof. Each distinct input may be further coupled to specified gestures by a user, e.g., index finger pointing or moving, to further diversify the breadth of corresponding executable functions.

In additional implementations the system may include a power module configured to power on or off the ring input device. In exemplary implementations, the power module may change state based on whether it is being worn or stored, or based on its detected position on a user's finger. For example, the power module may change state depending on whether the ring is positioned on the base of the finger (e.g., proximal phalange) or middle phalange, e.g., transitioning to standby mode when moved away from the middle phalange. Or for example, the power module may change state based on whether the ring input device is in storage or in active use. The ring input device may be stored with the XR component, e.g., on an XR headset, when not in active use. Additionally, the power module may comprise a power-saving feature that puts the ring input device into a standby mode when not in use. The power-saving feature may be designed to activate after a certain period of inactivity. The power-saving feature may also be designed to activate based on certain conditions such as low battery level, low signal strength, or a combination thereof. Additionally, the power module may be rechargeable via various mechanisms for example wirelessly, with a designated stand, or in conjunction with the XR component.

In exemplary implementations, a method of interacting with a computing device using a ring input device comprises: wearing the ring input device on a user's middle phalange; establishing a connection between the ring input device and the computing device, e.g., wired, wireless, or any other operable connection; receiving input from the user's thumb on the touch-sensitive surface disposed on the ring input device; and transmitting the received input to the computing device for execution of corresponding actions. The ring input device may receive input without requiring substantial bending of the thumb, for example, without substantial bending of the interphalangeal joint, e.g., no more than about 45°, 40°, 30°, 20°, or for example 15° from the thumbs natural position.

The method may further comprise a tracker module configured to track the movement of at least one of the user's fingers and using the tracked finger movement as additional input for the computing device. The method may further comprise the computing device being configured to receive input from both the touch sensitive surface of the ring input device and the tracker module simultaneously. For example, the tracker module may track the movement of the user's index finger and transmit the index finger input to the computing device for execution of corresponding actions. The input of the ring input device and the input of the tracked finger may be transmitted to the computing device simultaneously and or in combination for execution. The tracked finger may have freedom of movement. That is, it may have near complete, or at least substantial, or more than 80 percent freedom of movement, that is normal range of motion. For example, in exemplary implementations where the ring-input device is coupled to the middle phalange of the middle finger of the user, concurrent thumb and ring-input device interaction may not disrupt the index finger freedom of movement or the tracker modules monitoring of the tracked finger. Exemplary implementations further comprise an augmented, virtual, or a mixed reality environment, collectively referred to as an extended reality or XR environment. The tracker module may be integrated into the XR environment or computing device, or operably coupled to the XR environment or computing device. Likewise, the XR environment and computing device may be operably coupled or fully integrated.

In further exemplary implementations, the computing device is configured to receive input from both the touch-sensitive interface of the ring input device and tracker module simultaneously and execute simultaneously. The computing device may additionally be configured to process additional varieties of inputs such as gestures, voice commands, gaze direction, or combinations thereof. The computing device may also be designed to support various output methods such as visual display, audio feedback, haptic feedback, or a combination thereof. In additional implementations, instead or in addition to index finger pointing the tracking module may be configured for gaze tracking, gesture tracking, other body movement tracking, or combinations thereof.

In implementations where the tracker module monitors finger pointing, the tracked finger, e.g., the index finger, has freedom of movement and the tracker module may be operably configured to track finger movements such as pointing, sliding, tapping, swiping, or a combination thereof. The tracker module may also be configured to track finger positions such as fully extended, partially bent, fully bent, or a combination thereof.

The received input from the ring input device and tracker module corresponds to executable actions wherein the executable actions comprise at least one of: scrolling, clicking, selecting, moving a cursor, zooming, firing shots in a first-person shooter game, reloading in a first-person shooter game, manipulating 3-dimensional content, interacting with virtual UI elements, initiating a voice-based interaction, grabbing, rotating, powering on, powering off, application-specific actions, or any combination thereof. Application-specific actions may be customized to accommodate a user's required objective. For example, for objectives such as training surgeons, pilots, other XR simulation or training modules, virtual drone piloting, depicting simulated architecture, presenting XR simulations, collaborations, gaming, or other desired objectives and purposes across fields. The method of the present disclosure provides a wide range of interactive possibilities for the user.

In additional implementations the tracker module may comprise at least one of: an image capture module with cameras, optical sensors, inertial measurement units, electromagnetic tracking, or a combination thereof. The image capture module may also be configured to capture various types of images such as still images, video images, or a combination thereof. The tracker module may also detect additional desired movements, gazing, gestures, or commands.

Furthermore, manipulating 3-dimensional content may comprise at least one of: resizing, shaping, sculpting, repositioning, rotating, animating, grouping, duplicating, or combinations thereof. This feature provides a wide range of intuitive creative possibilities for the user as well as possibilities to collaborate and present 3-dimensional content. The 3-dimensional (3D) content may comprise various types of objects such as shapes, models, characters, environments, or a combination thereof. The 3D content may also include various types of textures such as solid colors, gradients, patterns, or a combination thereof.

The method may further comprise tactile feedback to the user upon receiving input. The tactile feedback may comprise direct physical feedback e.g., from a physical click or spin, or various types of vibrations, pulses, or a combination thereof.

In another aspect, the method may comprise an additional ring input device and tracker module in communication with the computing device. The additional ring input device and tracker module may be operably coupled to the computing device and provide a second tracked finger input, and a second ring input. In further exemplary implementations, the method comprises additional executable actions corresponding to input from the first ring input device, the first tracker module, the second ring input device, the second tracker module, and any combination thereof. This feature presents a wider range of interactive possibilities for the user since additional executable actions are possible, and may include various game-specific actions, application-specific actions, or a combination thereof. Examples are expounded throughout the present disclosure.

Furthermore, disclosed herein is a method for inputting a plurality of distinct executable actions on the same hand of a user, in a system comprising at least one ring input device configured to be worn on the user's middle phalange and to receive input from the user's thumb on a touch-sensitive surface disposed on the ring input device, at least one tracker module configured to at least receive input from the user's index finger, at least one computing device and an augmented reality, a virtual reality, or a mixed reality environment, operably coupled thereof, and operably configured to receive the input and execute corresponding actions the method comprising: inputting an executable action by the thumb interacting with the touch-sensitive surface, or the index finger interacting with the tracker module, or combinations thereof; receiving input from the ring input device, the tracker module, or combinations thereof; executing a corresponding action on the at least one computing device, or XR environment, or combinations thereof.

In additional implementations, the method further comprises the ring input device being configured to be worn on the middle phalange of the user's middle finger. This feature also allows the index finger to have freedom of movement, unconstrained by the ring input device. Additionally, the tracker module may specifically be configured to track index finger pointing, bending, other movements or a combination thereof. In exemplary implementations the computing device and XR environment may receive and execute corresponding actions simultaneously. That is, they may receive simultaneous and distinct input from the tracker module and input ring, and they may execute actions simultaneously. The XR environment and computing device may be integrated or operably coupled. Likewise, the tracking module may be integrated or operably coupled with the XR environment and or computing device as well.

Corresponding actions of the disclosed method may comprise at least one of: scrolling, clicking, selecting, moving a cursor, zooming, firing shots in a first-person shooter game, reloading in a first-person shooter game, manipulating 3D content, interacting with virtual UI elements, other analogous actions, application specific actions, customized actions, or any combination thereof. The present disclosure provides a wide range of interactive possibilities for the user and illustrates the present disclosure's utility across various applications.

The method may additionally comprise additional inputs from a second hand's second ring input device and a second tracker module, wherein additional executable actions corresponding to input from the first ring input device, the first tracker module, the second ring input device, the second tracker module, or combinations thereof. The additional inputs may include various application-specific actions such as those implementations described in the present disclosure but not limited by the presently described implementations.

Further implementations may comprise at least one ring input device in a plurality of configurations, that is on the middle phalange of any one of the fingers on either hand, and in another aspect at least one additional ring input device in one of a plurality of configurations on any of the fingers on either hand, and so forth.

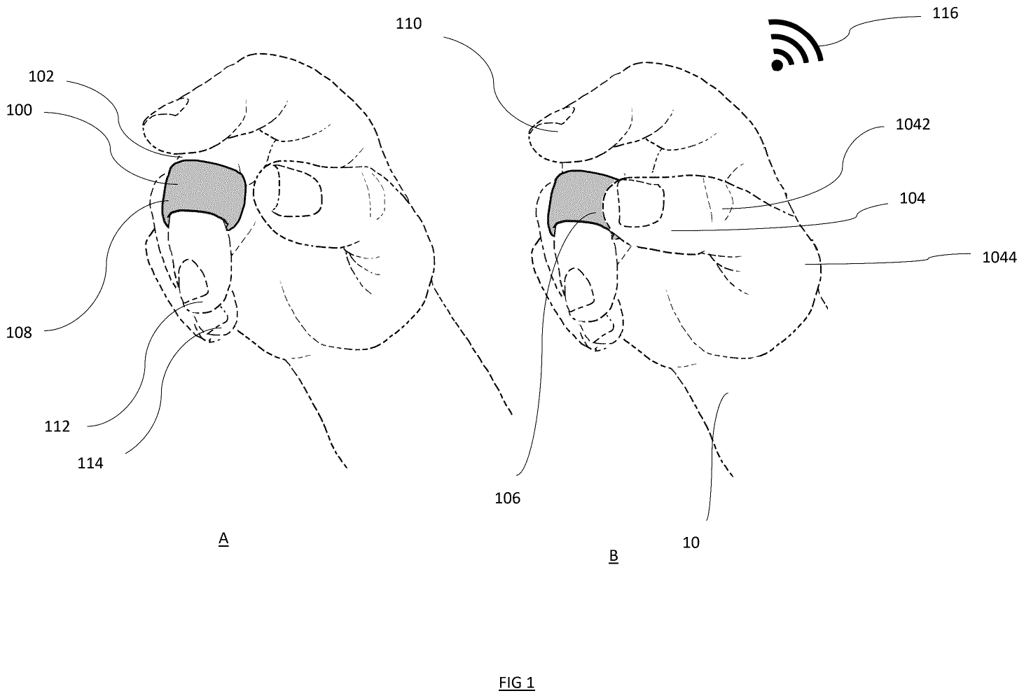

Referring now to the drawings, FIG. 1A illustrates an implementation of a ring-shaped input device or input ring denoted ring device 100, designed to be worn on user 10's middle phalange 102. Ring device 100 comprises touch-sensitive surface 106 and ring body 108. Ring body 108 is shaped and sized to fit around middle phalange 102 of middle finger 112, thereby operably configuring touch-sensitive surface 106 for interaction with thumb 104. In additional implementations ring body 108 may be adjustable. In exemplary implementations, ring body 108 may also comprise at least a portion made of elastomeric material. Additionally ring body 108 may have a plurality of shapes and sizes. For example, in exemplary implementations, ring body 108 may be generally ‘C-shaped’ and comprise an opening. Ring body 108 may also have varying thickness and surface area around the diameter of the ring, e.g., thicker and or wider on the dorsal and ventral facing sections. In an exemplary implementation of a ‘C-shaped’ ring body, there may be elastomeric material on the portion of the ring opposite the opening to enable live hinge-type function, that is ‘opening’ and ‘closing’ of the ring for donning and doffing and comfortable wearing. The open section of a C-shaped ring may span a relatively small angular segment while closed, such as approximately 1° to 5°, 10°, 15°, or 20° of the ring's circumference. Similarly, the portion of the ring forming a live hinge-type elastomeric material may occupy an angular segment of about 5° to 10°, 15°, or 20° of the ring body.

The ring body may be made of at least one additional elastomeric portion, e.g., near the opening of the ring body in implementations with a general C-shape. In other implementations the ring body may have a plurality of elastomeric portions spaced at pre-determined intervals. In yet other implementations, the ring body may be made of about 5-85% elastomeric material. For example, the inner facing portion of the ring body may be elastomeric, with the touch-sensitive surface and other components of the ring input device mounted in a pre-determined configuration on the outer facing surface. Other components of the ring input device may comprise, for example, at least one of: the touch sensitive surface's associated wiring and sensors, a microprocessor, a microcontroller, a Bluetooth antenna and associated circuitry configured to enable wireless communication with the computing device and or XR system, a battery or power source, a charging interface, memory storage, LED indicators or micro-display, or combinations thereof.

Ring device 100, as illustrated in the implementation of FIG. 1, is designed to comfortably receive input from thumb 104. Touch-sensitive surface 106 is positioned such that thumb 104 may interact with it without substantially bending interphalangeal joint 1042 and or metacarpophalangeal joint 1044 especially compared with a ring positioned on the base of index finger 110. The ergonomic design contributes to user comfort and ease of use over extended periods of use. In certain implementations, interphalangeal joint 1042 is not required to substantially bend to interact with touch-sensitive surface 106. Substantially generally may mean more than 50% from resting position. In additional implementations, interphalangeal joint 1042 may not be required to bend more than about 45° or more than about any angle between 15°-45°, or for example more than 15°−25°. Furthermore, ring device 100 is operably configured to allow freedom of movement for index finger 110. In other words, thumb 104 and touch-sensitive surface 106 may interact without inhibiting movement of index finger 110 as it interacts with a tracking module, thereby facilitating smooth interaction and input. As illustrated in the implementation of FIG. 1B, the thumb crosses to the plane of the middle finger and interacts with middle phalange 102 in a plane lower than that of index finger 110, thereby not substantially impeding the range of motion of index finger 102. User 10 interaction with ring device 100 requires minimal user effort, that is movement away from the hands natural or resting position but can still achieve a plurality of inputs and corresponding executable actions.

Touch-sensitive surface 106 of ring device 100 is designed to receive various types of input from thumb 104, such as taps, swipes, double taps, and long-presses. Possible implementations of touch-sensitive surface 106 are further described later in the present disclosure.

As illustrated in FIG. 1B, ring device 100 receives input from thumb 104. Thumb 104 interacts with touch-sensitive surface 106 to input commands, which are then transmitted to an operably coupled computing device (not shown), for example via wireless signal 116. Wireless signal 116 may be a Bluetooth signal, Wi-Fi signal, or any other suitable wireless communication technology. Ring device 100 is thus capable of operating as a wireless controller for a computing device.

Ring device 100 may also include a power module (not shown) configured to power on or off the ring input device based on its position on user 10's finger. For example, the power module may be configured to automatically power off ring device 100 when it is removed from user 10's finger. The power module may also include a power-saving feature that puts the ring input device into a standby mode when not in use, thereby conserving battery life. The power module for example may include a USB or USB-C charging station that may charge ring device 100 wirelessly or may be charged concurrently with the XR headset. Further implementations may include ring input device entering standby mode or powering off based on its configuration on a user's finger, for example, switching to standby mode or powering off when positioned at the base of the finger or when removed. Other implementations may store the ring input device with a corresponding integrated XR headset/computing device. For example, on a prong or tine on an XR headset configured for storing the ring input device while not in use.

In summary, FIGS. 1A and 1B illustrate ring device 100, configured to be worn on middle phalange 102 and to receive input from thumb 104. Ring device 100 is configured to facilitate intuitive, accurate, and comfortable interaction with a computing device, making it particularly useful for applications in virtual reality, augmented reality, and mixed reality environments.

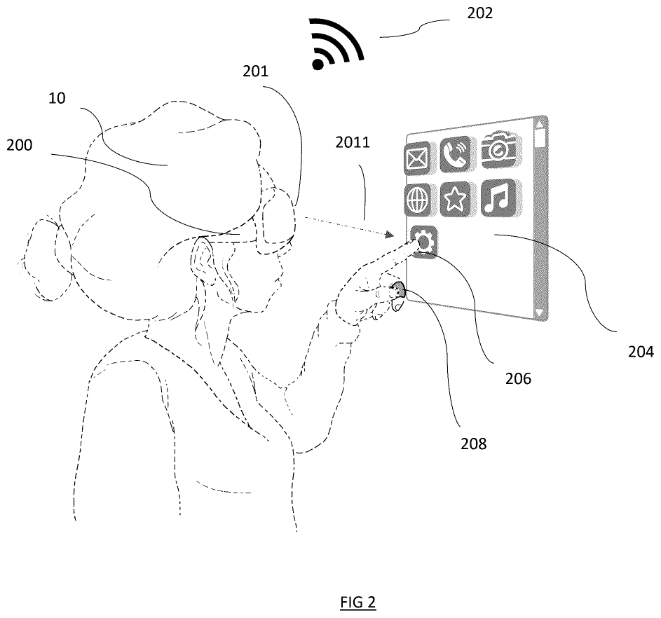

FIG. 2 illustrates an implementation of a use of ring device 10 in an XR environment. User 10 wears XR headset 200 and enters ring input 208 and pointing input 206. Pointing input 206 is tracked by tracker module 201 that is integrated in XR headset 200. Tracker module 201 may also be implemented separately or in conjunction with the computing device. In this implementation, the computing device is also integrated in XR headset 200. FIG. 2 illustrates user 10's interaction with virtual user interface (UI) 204 via wireless signal 202, transmitted to the integrated computing device and XR headset 200. Ring input 208 and pointing input 206 are executed and reflected on virtual UI 204. For example, pointing input 206 controls a cursor, and ring input 208 controls clicking or selection commands.

XR headset 200 is operably coupled to both ring device 100 and tracker module 201, and it is configured to receive ring input 208 and pointing input 206 simultaneously and execute actions corresponding to the received inputs in the XR environment.

Wireless signal 202 may represent the communication link between ring device 100, tracker module 201, and XR headset 200, enabling the devices to exchange data and commands, and enabling user 10 to interact with virtual UI 204 in real time. Additionally, virtual UI 204 may be generalized to any digital interface displayed to the user via XR headset 200. For example, in some implementations, XR headset 200 may display the interface with head mounted display or heads up display. XR headset 200 may be virtual, augmented, or a mixed reality headset. Examples of augmented and mixed reality headsets include HOLOLENS 2, MAGIC LEAP, etc., the technology is continuously developed and improved. Any application-specific digital interface may be manipulated by user 10 through ring input 208 and pointer input 206, enabling actions such as scrolling, selecting, manipulating, and more.

A notable feature of this exemplary implementation is tracker module 201's clear line of sight to the tracked finger to receive pointing input 206. Tracker module 201's line of sight (LOS) 2011 is uninhibited by simultaneous ring input 208. In additional implementations, LOS 2011 of pointer input 206 may be uninhibited while user 10's hand is rotated about 90° during interaction, or about 45° during interaction, or for example while the back of the hand is facing upwards (about 0° rotated). In other implementations user 10's hand may be rotated from about 0°-90°, or 0°-100° and tracker module 201 may still maintain uninhibited LOS 2011.

Furthermore, tracker module 201 may in alternative implementations be configured for gaze tracking, such that it would track LOS 2011 in lieu or in addition to finger pointing. For example, user 10's gaze may control the cursor through gaze tracking integrated in XR headset 200, and selection input would be made via ring device 100. Alternative implementations may comprise a tracking module that combines both pointing input and gaze tracking input to further increase accuracy. Other input methods (voice, additional tracking, gestures) may be added and combined as well in additional implementations to enhance the presently disclosed system, methods, and immersive user experience.

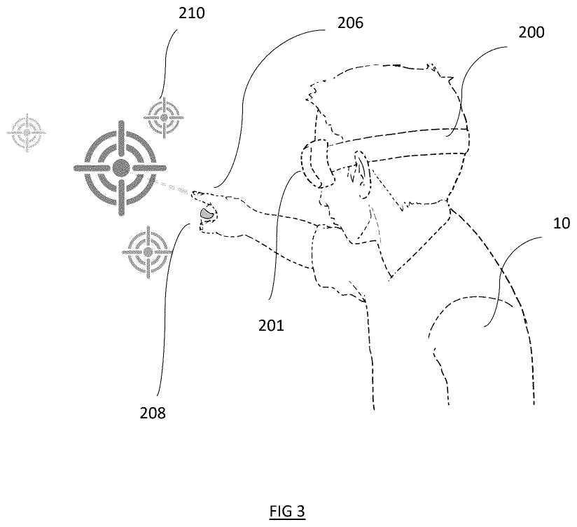

FIG. 3 illustrates another implementation of simultaneous ring input 208 and pointer input 206. User 10, wears VR headset 200, and plays a first-person shooter game. Notably, VR headset 200 may generally be implemented as any XR device such as glasses, headsets, projections, tethered, non-tethered, etc. For example, headset 200 may be META QUEST 3, APPLE VISION PRO, etc. In the implementation of FIG. 3, user 10 uses VR headset 200 with integrated tracking module 201, and ring device 100, operably coupled, to interact with virtual targets 210 via pointer input 206, which aims a virtual gun for example, and ring input 208 which may trigger firing the gun for example. Ring input 208 may comprise additional types of inputs such as weapon selection, reloading, intensity of firing, etc. For example, reloading, upon double click, weapon selection upon a click followed by a swipe, firing intensity controlled by the length of a press and hold release, etc.

As illustrated in FIG. 3, ring input 208 does not impede on the freedom of movement of the index finger and thus pointer input 206. Additionally, as illustrated, ring input 208 does not require substantial bending of the thumb during interaction. Or in additional implementations, bending at more than any angle between about 25°-50°. Also, ring device 100 is operationally configured to allow freedom of movement of the user's index finger, allowing near full range of motion and thus a large range of pointing input 206. In the present implementation, the hand is rotated near 0°, that is with the back of user 10's hand facing upwards. Tracker module 201 may track or monitor pointing input 206 without impediment from ring input 208. This aspect is also present in implementations where user 10 hand is rotated from about 0°-100°, or 0°-90° for example. The method of user and XR/computing device interaction, as depicted, is quite intuitive, easy to use, natural, and comfortable for user 10. Similar types of input interactions can be implemented for a plurality of application-specific uses and for either augmented, virtual, or mixed reality environment interactions.

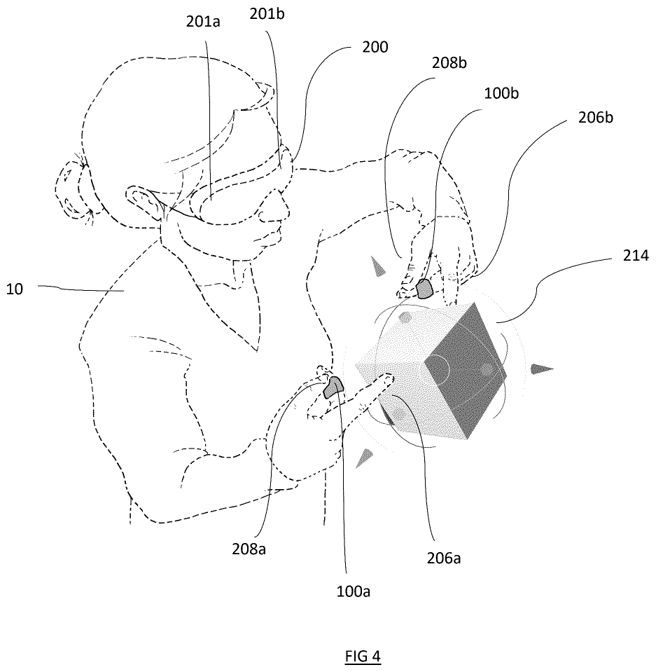

Turning now to FIG. 4, an exemplary implementation of dual ring and dual pointer input is illustrated. User 10 wears right input ring 100a, left input ring 100b, which transmit right ring input 208a and left ring input 208b, respectively. Additionally, right pointer input 206a and left pointer input 206b may be tracked by corresponding tracking modules 201a and 201b respectively, integrated in XR headset 200. Alternatively, tracker modules 201a and 201b may be integrated or combined as one tracker module monitoring each tracked finger. XR headset 200 creates the XR environment, in this implementation the XR environment in which to interact is virtual 3D object 214. User 10 interacts with XR headset 200 which is integrated with the computing device (e.g., standalone, tethered, etc.) and may be operably coupled to the computing device (e.g., tablet, PC, etc.) in other implementations. Using both right ring input 208a and left ring input 208b simultaneous and in combination with right pointer input 206a and left pointer input 206b, user 10 manipulates virtual 3D object 214. Manipulations may comprise resizing, shaping, sculpting, repositioning, rotating, animating, grouping, duplicating, or combinations thereof.

Additionally, as depicted in FIG. 4 a user may dual-select rings 100a, and 100b simultaneous with dual-pointing input 208a and 208b respectively to grab and rotate 3D object 214. Additional executable actions may also comprise zooming or scaling by changing the distance between two index fingers, rotating 3-dimensional virtual objects or virtual user-interface elements by offsetting the angle between two index fingers, painting or drawing tools where one hand may control drawing or painting while the other hand supports the color pallet or an alternative artistic tool, dual wielding in a specified virtual game where a user may control an object in each hand such as a sword and a shield, two guns, etc. or additionally driving applications where for example one hand input orients the car and the other ring input controls the speed. In immersive driving or pilot training applications each input option and combinations thereof may reflect a relevant command. For virtual medical or anatomical training, single input, dual inputs, and combinations may reflect different surgical tools and techniques. For map or immersive exploration applications, pointing and selecting may generally direct the user within the XR environment, and the second hand's selection may allow for precise exploration and selection of specific features within the XR environment. These and other implementations illustrate the diversity of applications the input methods and systems of the present disclosure may be applied to, in dual ring or single ring form, or in other configurations.

In dual ring form as in FIG. 4, user 10's thumbs may interact with the touch-sensitive surfaces of both input rings configured on respective middle phalanges of the middle fingers without requiring substantial bending of the thumbs, and while simultaneously or concurrently providing pointing input 208a and input 208b to the system with clear line of sight 2011 for tracker module 201a and 201b.

Both tracker modules of right pointer input 206a and left pointer input 206b respectively may be integrated with XR headset 200 and or may comprise image capture modules, optical sensors, inertial measurement units, electromagnetic tracking, or combinations comprising one or more of the foregoing. XR headset 200 may also be operably coupled to additional computing devices, processors, AI modules, microphones, speakers, or other systems to expand the range and accuracy of user interaction and output.

In this system, the ring input devices, the integrated computing device and XR headset 200, 3D object 214, and tracker modules are operably coupled for example through a wireless connection such as Bluetooth technology. This wireless connectivity facilitates the interaction and execution of actions in the virtual reality environment. As mentioned, the system may also comprise a power module with all the previously described characteristics incorporated herein.

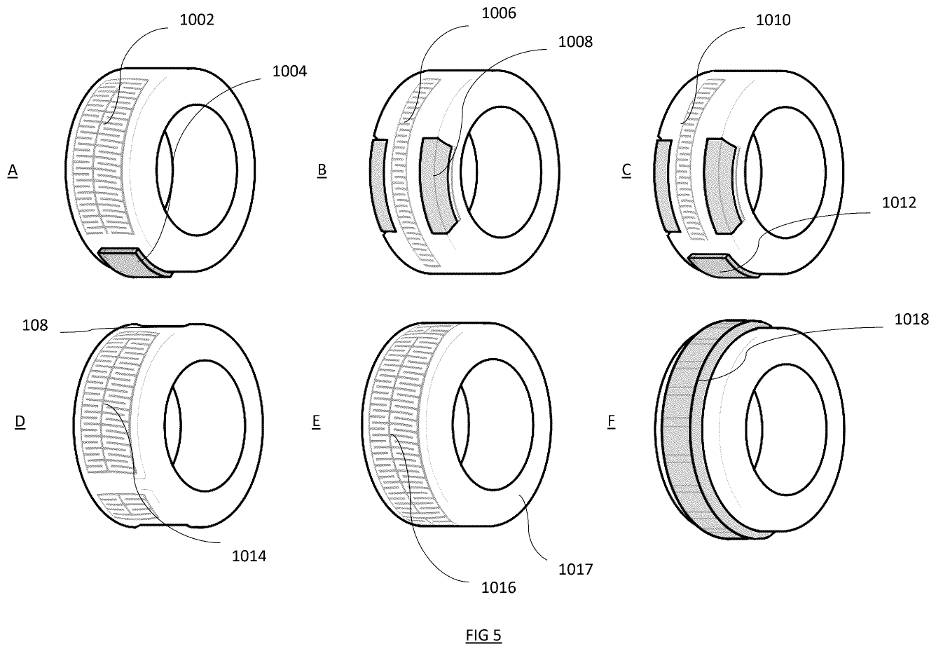

Turning now to FIG. 5, several implementations of ring device 100's touch-sensitive surface 106 are illustrated. As described herein, the touch-sensitive surface 106 may be comprised of a plurality of components arranged around the entire outward facing surface of the ring body, or segmented on a ventral and dorsal surface of the ring body, and or with components on the distal and proximal facing ends. The following embodiments do not limit the scope of possible configurations of the touch-sensitive surface 106 and may also be applied to implementations with elastomeric portions, live hinges, and C-shaped ring input devices, for example.

FIG. 5A is an implementation with wide touch sensor 1002 which may, for example, be a clickable wheel or touch pad. A wide touch sensor may register a variety of touch gestures, such as swipes in pre-determined directions, taps, scroll, and long presses, for user interaction. Wide button 1004 may be pressed or clicked to execute specific actions, providing a distinct, tactile feedback to the user upon activation. In exemplary implementations, wide button 1004 may be configured as a button to initiate a voice-based interaction for example with a microphone operably coupled to an AI or similar type module. A user may be able to scroll in at least two directions on wide touch sensor 1002, click, double click, press and hold, and swipe and click, and or also hold wide button 1004 to activate a microphone on an XR headset, e.g., headset 201, and record a voice prompt for processing and or execution by the AI module. The AI module may be integrated or operably coupled to the computing device or XR system and may comprise a processor for executing the corresponding executable instruction or transmitting executable instructions.

FIG. 5B depicts narrow touch sensor 1006 with narrow buttons 1008 on each side. Alternatively in FIG. 5C, narrow and shortened touch sensor 1010 may be implemented with narrow buttons 1008 and wide button 1012 at one end of narrow and shortened touch sensor 1010. This design combines the tactile feedback of a button with the versatility of a touch sensor, offering a hybrid interface for user input. The button may be pressed or clicked to execute specific actions, while the touch sensor may register a variety of touch gestures. A button, such as a narrow button 1008 may also be pre-designated to establish a Bluetooth connection with the computing device and or the XR system. Note that the implementation of button 1008 illustrates that a component of the touch-sensitive surface may extend from the outward facing surface of the ring body to the distal or proximal end facing surface of the ring body. Implementations where a component of the touch-sensitive surface may be arranged on the distal or proximal end facing surface of the ring body (not shown) are also within the scope of the present disclosure.

Additionally, in exemplary implementations wide button 1012 may be the designated button to initiate a voice-based interaction e.g., upon a click, a double click, a hold and release, or a double click hold and release. Wide button 1012 may activate a microphone operably coupled to or embedded in the XR system or the computing device. Upon activation, the microphone may capture audio input (e.g., a voice prompt) and transmit the recorded data to one or more AI modules in communication with the XR system or computing device. These modules may include, for example, an Automatic Speech Recognition (ASR) engine to transcribe the voice input, followed by a Natural Language Processing (NLP) engine, a Natural Language Model (NLM), a Large Language Model (LLM), a conversational AI system, or a voice assistant module. The processed input may then be used to generate executable instructions that, for example, generate a corresponding system response, control XR headset 201's functions, issue commands, retrieve information, or modify the user's immersive experience in real time.

In other implementations a microphone may be another component of the ring input device. As understood to one skilled in the art, the ring input device may also comprise a microprocessor, a microcontroller, a Bluetooth antenna and associated circuitry configured to enable wireless communication with the computing device and XR system, a battery or power source, a charging interface, memory storage, LED indicators or micro-display, or combinations thereof. For example, the charging interface may be a magnetic charging port, pogo pin connectors, or wireless inductive charging coil. For example, the microprocessor or microcontroller may be configured to process touch-sensitive surface input, manage communication protocols, control power states, and or transmit data via the Bluetooth or other communication module to the connected computing device or XR system.

Turning back to implementations of the touch-sensitive surface, FIG. 5d illustrates a wide clickable depressed touch sensor 1014 that is physically depressed relative to the surface of ring body 108. This depression may help to prevent unintentional input, while still allowing for a variety of touch gestures. The sensor is also clickable, providing tactile feedback upon activation. Turning now to FIG. 5e, wide clickable touch sensor 1016 is also clickable and provides tactile feedback to the user upon activation. In exemplary embodiments, distal or proximal side surface 1017 may comprise a plurality of touch-sensitive surface configurations as well. For example, side surface 1017 may comprise at least one button with a pre-determined function. FIG. 5f illustrates an implementation with wide protruding scroll wheel 1018. This design offers a tactile, rotating interface for user input. For example, the scroll wheel may be rotated to scroll providing a distinct, tactile feedback to the user upon use, it may also be clickable. As FIG. 5 illustrates, touch sensitive surface 106 may comprise a plurality of configurations of buttons, scroll wheels, touch sensors, touch pads, all a plurality of sizes and combinations in addition to what is illustrated herein. The optimal configuration may be determined for a specific application, or alternatively be chosen based on the configuration that is suitable for the largest range of specified applications. Additionally, each configuration of touch-sensitive surface may have components with pre-determined functions to be executed upon pre-determined input from a user's thumb. Pre-determined functions are not limited to establishing a Bluetooth connection, powering on or off, initiating a voice based interaction, selecting, scrolling, zooming, and other functions or combinations described herein.

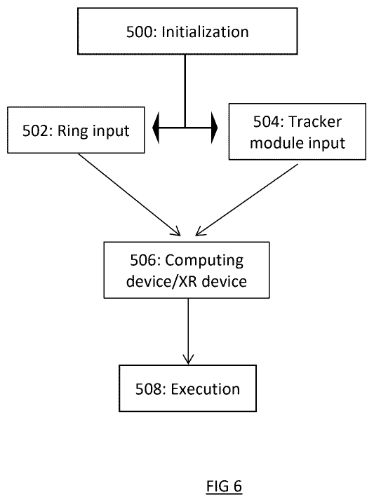

Turning now to FIG. 6, illustrating an exemplary implementation of a method of using ring input 502 and tracker input 504 to interact with integrated computing device and XR device, denoted computing device/XR device 506. In other implementations, the computing device and XR device may be integrated or operably coupled. The method begins with initialization process 500, followed by ring input 502 and tracker module input 504, which are then processed by computing device/XR device 506 to execute corresponding actions 508.

The initialization process 500 may comprise powering on the devices, wearing ring device 100, positioning ring device 100, establishing a connection between the ring input device, the tracker module, and computing device/XR device 506, preparing the system to receive and process inputs from the user, or a combination thereof. The computing device may use an XR environment as part of the specific XR device or application, or the XR environment may be enabled by applications such as OPENXR, STEAMVR, or other applications for example. The initialization process may also comprise charging ring device 100.

Ring input 502 and or tracker module input 504 may be received or transmitted to computing device/XR device 506 singularly or simultaneously. Computing device/XR device 506 processes both or either input received and executes 508, for example in the UI of an XR environment. Execution 508 may also comprise scrolling, selecting, zooming, firing shots in a first-person shooter game, manipulating 3D content, other interactions, or combinations thereof. Ring input 502 may be received in any configuration of touch sensitive surface such as illustrated in FIG. 5 but not limited to the arrangements described herein.

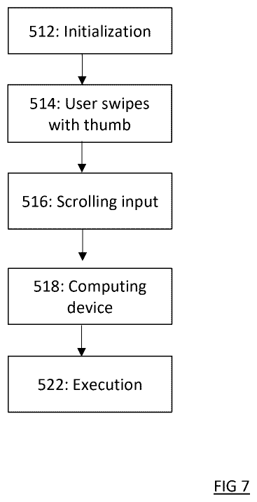

Turning now to FIG. 7, illustrating an implementation of a method to input a scroll command. The first step, initialization 512 resembles initialization 500, e.g., it may comprise positioning ring device 100 on the user's middle phalange, establishing a connection with computing device 518, or other steps as mentioned in initialization 500. Once initialization 512 is complete, the user may interact with ring device 100, for example by swiping ring device 100 as in block 514. The user's thumb movement on touch-sensitive surface 106 is transmitted as scrolling input 516 to computing device 518. Computing device 518 is configured to execute actions 522 corresponding to the received inputs, in this case, the action corresponds to scrolling. Execution 522 may occur in the display of the computing device. Alternatively, the system may comprise a virtual reality environment, an augmented reality environment, or a mixed reality environment that is coupled or integrated with the computing device and the execution is displayed within one of the XR environments. In exemplary implementations, the direction of the scrolling corresponds to distinct executions of the user input.

In additional implementations, the system may comprise at least one additional ring input device, at least one tracker module, at least two tracker modules, or combinations thereof. This would allow the user to perform additional executable actions corresponding to input from any one or combination of: the first ring input device, the first tracker module, the second ring input device, or the second tracker module.

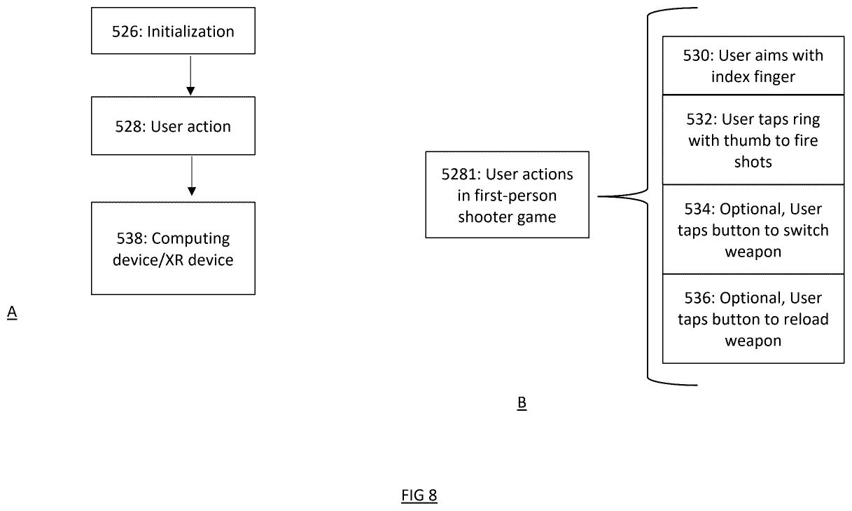

Referring to FIG. 8, a method depicting a general user action is depicted in FIG. 8A while an example of a user action in the context of an XR first-person shooter game is depicted in FIG. 8B. As above, the general method may start with initialization 526, which may comprise switching ring device 100 to an activated mode, operably configuring ring device 100, operably configuring the tracker module, operably configuring the XR environment and or computing device, or other initialization steps. Initialization may be followed by specified user action 528, which may correspond to a plurality of user inputs into the system. Action 528 is transmitted as a correlating user command to computing device/XR device 538 which may process or execute the specified user command. Where the context is an XR first-person shooter game, the user may execute relevant actions 5281, such as aiming with the index finger (530), firing shots by tapping the ring with the thumb (532), switching weapons (534) e.g., by swiping distally to proximally, or reloading the weapon (536) e.g., by double tapping or swiping side to side. User actions 5281 may be transmitted by the tracker module and ring-input device. For example, in action 536 there is a button designated to reload the weapon, a second button designated for action 534 to switch the weapon, and a touch screen or third button designated for firing shots (action 532), the index finger action 530 corresponds to aiming the weapon.

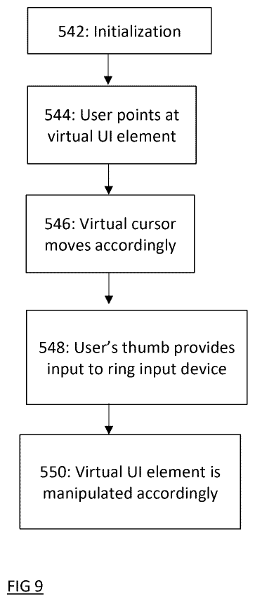

FIG. 9 illustrates another implementation of a user action combining pointing and clicking, for example in the context of a user and virtual user interface (UI) interaction. The method may comprise initialization (542), user pointing at a virtual UI element (544), virtual cursor movement (546), user's thumb input to the ring input device (548), manipulation of virtual UI element (550), and combinations thereof.

As in previously described systems, in this implementation the tracker module, ring device 100, XR environment, computing device, and any other system components must be operably coupled. Tracker module 201 transmits index finger pointing input 206, and ring device 100 transmits ring input 208. The advantage of this and other implementations herein is that ring input 208 does not inhibit pointer input 206. For example, as illustrated in FIG. 2, tracker module 201 implemented in XR headset 200 has a clear visual view (LOS 2011) of the index finger and may collect pointer input 206 without being inhibited from the user simultaneously providing ring input 208. Since ring input 208 does not inhibit pointer input 206, tracker module 201 may track the index finger without obstructed accuracy. Obstructions may be of the visual, movement, or ease of use type. Similarly, the user may comfortable and intuitively input commands (548), such as selection, through ring input 208 and pointer input 206 without compromising accuracy of either input. Pointer input 206 may move a virtual cursor (546) and ring input 208 may concurrently select, grab, or otherwise interact with dynamic virtual UI elements 550.

In this implementation, any input, such as input to move virtual cursor (546), is facilitated by the computing device which for example, receives the input from tracker module 201 and executes it into corresponding cursor movement within the virtual UI. Ring input 208 is similarly processed. Manipulation of the virtual UI (550) corresponds to the input received from ring device 100 and tracker module 201.

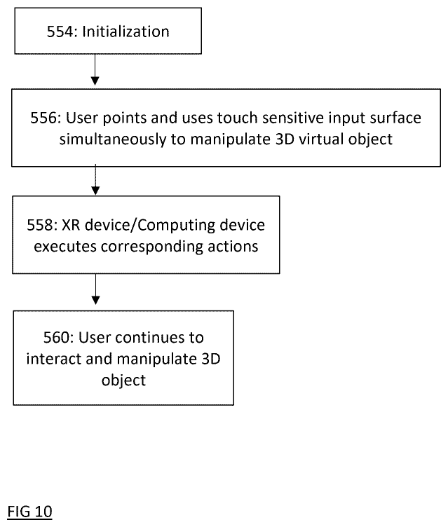

FIG. 10 illustrates an additional implementation of a method of manipulating a 3-dimensional (3D) virtual object with simultaneous ring and pointer input. Manipulation of the 3D object may comprise: initialization (554) as initializations discussed previously, simultaneous ring input and pointer input (556), processing and execution of the received inputs by the computing device (558), and additional input (560).

In block 556 ring device 100 receives input from the user's thumb on touch-sensitive surface 106, while tracker module 201 tracks the movement of index finger 110. The input from both ring input device 100 and tracker module 201 is then transmitted to the computing device. The user may point and use touch sensitive input surface 106 simultaneously or concurrently to grab, rotate, zoom, spread, spawn, sculpt, transform, or otherwise manipulate a virtual 3D object. Each command is executed (558) in the XR environment integrated with the computing device. To continue with the 3D virtual object interaction (560), a user simply enters additional input. These additional inputs correspond to additional executable actions in the XR environment. The present system may also be used in conjunction with other input systems complementary to the XR environment, for example, voice activation, gaze tracking, other movement tracking modules. For example, during interaction 556 a user may choose to send a voice prompt to change the color palette of the 3D virtual object, or the user may request AI generated suggestions, and in this way continue interacting and manipulating the XR environment with the ring input device.

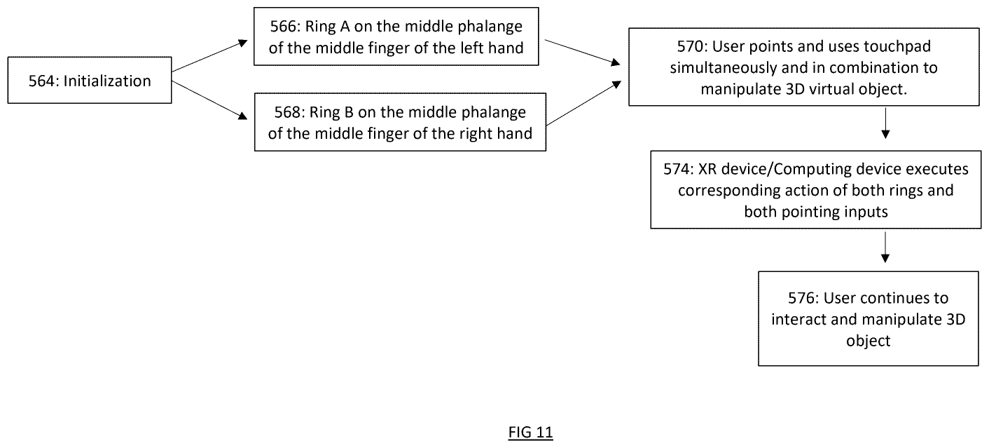

FIG. 11 illustrates a method of dual ring use, specifically virtual object manipulation. The method illustrates how a user may interact with a computing device using a system that comprises two ring input device and two tracker modules, to illustrate and not limit possibilities of interaction with a dual ring system. In other alternative systems, a user may have more than two ring input device and or more than two tracker modules in addition to other optional complimentary input systems.

The initialization 564 involves setting up the system for interaction as above, followed by positioning ring A on the middle phalange of the left hand (566) and ring B on the middle phalange of the right hand (568). The ring devices may be configured to receive input from the thumbs without requiring substantial bending. Furthermore, the ring input devices are configured to allow freedom of movement of the user's index fingers. After initialization and configuring the rings and as in previous block 556, the user may simultaneously point with both index fingers and use touch-sensitive surface 106 to input executable actions 570. With two ring input and two pointer inputs, there is a wider range of executable actions possible. Following input 570, the XR device/computing device may execute corresponding actions and user 10 may continue to input more actions, or in other words, interact and manipulate within the XR environment 576.

In additional implementations with dual ring devices, additional executable actions may comprise zooming or scaling by changing the distance between two index fingers, rotating 3-dimensional virtual objects or virtual user-interface elements by offsetting the angle between two index fingers, painting or drawing tools where one hand may control drawing or painting while the other hand supports the color pallet or an alternative artistic tool, dual wielding in a specified virtual game where a user may control an object in each hand such as a sword and a shield, two guns, etc., driving applications where for example one hand orients the car and the other hand input controls the speed, drone controlling where for example one pointer input directs and one pointer input controls tilt of a drone, other XR simulation scenarios of real world events requiring user input, or other XR scenarios in real time such as presentations, collaborations, games, or other XR experiences.

Additional dual ring implementations include examples such as where two rings are configured on the same hand, for example the middle phalange of the index and middle finger, middle and ring finger, or other combinations thereof. Additional implementations may comprise more than two rings, for example a ring configured on the middle phalange of every finger. The ring input device may also be coupled to other types of ring input device systems, for example those on other phalanges of the finger. For example, the ring input device may also be configured to be on the middle phalange of the middle finger, and operably coupled to another implementation of the ring input device configured to be on the proximal phalange of the middle finger. Alternatively, the ring input device may be configured for the proximal and middle phalange, thereby allowing a user to interact with two ring input devices on a middle finger. These implementations reflect ring device 100's plurality of possible finger configurations and may or may not be coupled with at least one tracker module. Also, the forementioned implementations may be coupled with input from the second hand with any of the plurality of ring input device configurations. For example, ring device 100 may be located on the middle phalanges of the index and middle finger of each hand with at least a tracker module for each index fingers pointing input. Additional tracker modules or system components to collect user input may also be incorporated into the system.

The present invention relates to an interactive system comprising at least a ring input device, an optional tracker module, and a computing device. This system is designed to facilitate user interaction with the computing device and in exemplary implementations with a virtual reality, augmented reality, or mixed reality environment, denoted by extended reality or XR.

Alongside the ring input device, the tracker module may be included in the system and configured to track the pointing of the user's index finger. The tracking of the index finger's pointing allows the system to interpret the user's finger movements as additional input. This capability expands the range of possible interactions with the computing device, enhancing the engagement and immersive experience of the user. The tracker module may be an image capture module, an optical sensor, an inertial measurement unit, an electromagnetic tracking device, part of a XR headset, or a combination thereof, and more than one module may be included in the system. In alternative implementations, the tracker module may be configured for gaze tracking either instead of or in addition to tracking finger pointing. In exemplary implementations, the tracker module is integrated in the XR environment, but may also be operably coupled. In further exemplary implementations, the system may comprise voice-interaction capabilities allowing the user to input a prompt to an AI module or similar module, operably coupled or integrated with the computing device or XR environment.

A feature of the present disclosure is the capability of the system to receive simultaneous input from multiple sources comfortably and intuitively. This feature is also present where additional ring input devices and or tracker modules may be present. The systems and methods disclosed herein may also be implemented in such a way that the range and complexity of possible XR interactions and applications is expanded.

The computing device, the XR environment, the at least one ring input device, and the at least one tracker modules may be operably connected or coupled via wireless technology such as Bluetooth, Wi-Fi, NFC, or a combination thereof.

Furthermore, the touch-sensitive surface of the ring input device may take a plurality of forms, such as at least one touchscreen, touch sensor, scroll wheel, button, or combinations thereof. It may also be depressed relative to the body of the ring input device to further prevent unintentional input, and be composed of one or more pre-designated buttons Moreover, the touch-sensitive surface may provide and or require physical tactile feedback to the user upon receiving input, further enhancing the user's interaction experience, and preventing unintentional input. And at least a portion of the body of the ring input device may be composed of elastomeric material.

Comparatively, the present disclosure offers significant efficiency and comfort over traditional systems. The combined use of the ring input device on a user's middle phalange and the tracker module allows for a more intuitive and natural interaction with the computing device within a XR environment. Furthermore, exemplary implementations wherein the ring input device is configured on the middle phalange of the middle finger require the middle finger to slightly lower and the thumb to move to the middle phalange of the lowered middle finger to input an action (such as ‘select’ with a click for example). This user movement is not one likely to be performed unintentionally, although it is a comfortable and subtle movement. Thus, a user may stay connected to an XR environment and perform everyday tasks with less likelihood of unintentional input. In exemplary implementations, the required movements for using the ring input device—deliberate thumb movement toward the middle phalange—is unlikely to occur unintentionally during natural hand use, thereby reducing accidental activation while maintaining case of use. In other words, the present system and methods avoids and has less risk of false positives.

This advantage contrasts to current XR interaction practices, and contributes to a more efficient, comfortable, and less frustrating XR interaction experience.

Moreover, systems and methods presented here may be applied to various fields like gaming, virtual reality education, medical training and education, augmented reality tours and guides, virtual training and simulations, presentations, collaborations, object manipulation, and mixed reality entertainment, to name a few. Thus, the present disclosure offers a versatile and flexible interaction platform suited to various environments.

Other implementations are possible, and modifications may be made to the implementations without departing from the spirit and scope of the present disclosure. As such, these implementations are only illustrative of the inventive concepts contained herein.

### Definitions

“Comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having”, “containing”, and their derivatives.

“Communicate” (and its derivatives e.g., a first component “communicates with” or “is in communication with” a second component) and grammatical variations thereof are used to indicate a structural, functional, mechanical, electrical, optical, or fluidic relationship, or any combination thereof, between two or more components or elements. As such, the fact that one component is said to communicate with a second component is not intended to exclude the possibility that additional components can be present between, and/or operatively associated, connected, coupled, or engaged with, the first and second components.

The term “system” shall also be taken to include any collection of systems or sub-systems that individually or jointly execute a set, or multiple sets, of instructions to perform one or more functions.

The term “coupled”, and its various forms such as “operably coupled”, “coupling” or “couplable”, or related terms like “connected” refers to and comprises any direct or indirect, structural or functional coupling or connection, or adaptation or capability for such a direct or indirect structural or operational coupling, connection, or attachment, as well as integrally formed components and components which are coupled via or through another component or by the forming process. Indirect coupling may involve coupling through an intermediary member or adhesive, or abutting and otherwise resting against, whether frictionally or by separate means without any physical connection. “Operably coupled or connected” refers to the operable, functional, or structural joining of two members directly or indirectly to one another. Such joining may be stationary in nature or moveable in nature. Such joining may be achieved with the two members (or the two members and any additional intermediate) being integrally formed as a single unitary body with one another or with the two members or the two members and any additional members being attached or in communication with one another. Such joining may be permanent in nature or may be removable or releasable in nature. The joining of two or more elements in an operable coupling or connection may include a wireless joining or a wired joining, for example.

As used herein, the term “elastomeric material” refers to any material capable of undergoing elastic deformation under an applied stress or strain and returning substantially to its original shape and dimensions upon removal of the stress. Elastomeric materials may exhibit flexibility, stretchability, and resilience, making them suitable for repeated mechanical deformation. Examples of elastomeric materials may include, without limitation, silicone rubber, thermoplastic elastomers (TPE), natural rubber, polyurethane elastomers, nitrile rubber (NBR), and similar synthetic or natural polymeric substances possessing elastic or rubber-like mechanical properties. In some embodiments, the elastomeric material may be biocompatible and suitable for prolonged skin contact. In the context of the present disclosure, elastomeric materials may be used to form or reinforce at least a portion of a wearable device (e.g., a ring input device), such that the device may stretch, flex, or deform to facilitate donning, conforming to anatomical contours, or removal, while maintaining structural integrity and user comfort.

A “computing device”, in the broadest sense, is any device that can perform computational tasks or process data. This includes traditional devices like desktop computers, laptops, and servers, as well as mobile devices like smartphones and tablets. Additionally, the term “computing device” may refer to a variety of devices capable of supporting virtual reality (VR), augmented reality (AR), mixed reality (MR), or extended reality (XR) environments. The term also encompasses variations such as: A) “Standalone Computing Device” which is a traditional computer or a mobile device that may have the necessary hardware and software to support XR applications. This might include a high-performance graphics card, a powerful processor, sufficient memory, and specialized software. The user may interact with the XR environment displayed from the device. B) “Computing Device with XR Component”, which is a computing device that is connected to an external XR component, such as but not limited to a virtual reality (VR) headset, an augmented reality (AR) headset, or a mixed reality (MR) headset. The computing device runs the XR application and sends the visual output to the headset. The headset may include the tracker module to track the user's movements and send this data back to the computing device. C) “Integrated XR Computing Device”, where the computing device and the XR components are integrated into a single unit. For example, a standalone VR headset, which has its own built-in processor, memory, and storage to run VR applications without needing to be connected to a separate computing device. The user interacts with the XR environment directly through the integrated device. In all these variations, the user can interact with the computing device using the ring input device and the tracker module as described in the present disclosure. The specific form of the computing device can depend on the requirements of the XR application and the user's preferences. The term XR “environment”, system, or module are general terms that encompasses the virtual, augmented, or mixed reality in which a user may interact. Crucial to the environment is the display which may place a combination of virtual and physical world objects in a user's field of view depending on the level of immersion. The XR device used to interact in the XR environment may be a head mounted display (HDM), an XR device resembling eyeglasses, a head-up display (HUD), passthrough, XR contact lenses, a handheld display, a projection mapping display, or other similar XR devices currently available or in development.

As used herein, the term “processor” or “processing unit” broadly refers to any electronic circuitry that carries out instructions by performing basic arithmetic, logic, control, and input/output operations. The processor may be a component of the computing device, the XR environment (e.g., integrated within an XR headset or accessory), or distributed across multiple devices in communication with one another. In various embodiments, the at least one processor is in communication with a non-transitory memory device storing thereon a set of executable instructions configured, when executed by the processor, to execute actions corresponding to one or more user inputs received from the ring input device, the XR interface, or another peripheral system. Examples of processors may include but are not limited to: Central Processing Units (CPUs), Graphics Processing Units (GPUs), Field-Programmable Gate Arrays (FPGAs), Application-Specific Integrated Circuits (ASICs), Programmable Logic Controllers (PLCs), System-on-Chip (SoC), Digital Signal Processors (DSPs), Microcontrollers (MCUs), Neuromorphic Processors, Edge AI Processors, Cloud-Based Processors or Virtualized Compute Instances. In various embodiments, one or more of the above processors may be included in or operably coupled with the ring input device, tracking module, the XR system (e.g., headset, glasses, display), or the computing device. The processor(s) may execute the aforementioned instructions stored in the non-transitory memory device to interpret inputted data, recognize gestures, process user commands, manage communications, or control real-time responses in a virtual, augmented, or mixed reality environment.

The “tracker module”, as described in the present disclosure, is a component that tracks user's movement of at least one finger, for example, the pointing of the user's index finger. This module can come in various forms and can be integrated in different ways within the system: 1. Integrated with the Computing Device: In this variation, the tracker module is built into the computing device itself. This may be the case if the computing device is a personal computer (pc) or tablet equipped with a built-in camera or sensor that can track the user's finger movements. 2. Integrated with the XR Device: If the system includes an XR headset (such as a VR, AR, or MR headset), the tracker module may be integrated into the headset. Many XR headsets come with built-in sensors or cameras that can track the user's movements. In this case, the tracker module would use these sensors to track the pointing of the user's index finger. 3. Separate Tracker Module: The tracker module may also be a separate device that is not integrated with the computing device or the XR device. This may be a standalone camera or sensor that is positioned to track the user's finger movements. The tracker module may communicate with the computing device and/or the XR device wirelessly or via a wired (e.g., USB) connection to transmit the tracking data. 4. Combination: The system may also use a combination of the above. For example, it may use the sensors in an XR headset in combination with a separate tracker module to improve the accuracy and reliability of the tracking. In all these variations, the tracker module may be operationally configured to track at least one finger, e.g., the pointing of the user's index finger, and transmit the tracked data to the computing device for execution. Examples of motion tracking technologies are not limited to digital cameras, optical sensors, infrared sensors, etc. or combinations thereof, and may be combined with other technologies such as artificial intelligence, machine learning, or other specialized models or algorithms to increase the accuracy of the tracking module. For example, a gaze tracking component may be a component of the tracker module and used in conjunction with index finger tracking.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about”, “approximate”, or “near” whether or not expressly stated to be such.

The term “module,” as used herein, means, but is not limited to, a software or hardware component, such as a field programmable gate array (FPGA) or an application specific integrated circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The term “substantial” is used to describe a certain degree or extent of a characteristic, action, or method that does not have to be absolute or complete but is significant or considerable. For example, “substantial bending” or “substantially bending” may broadly refer to bending of more than 50° from the natural or rest position. “Rest position” is when a hand is relaxed, the thumb naturally rests in a position abducted (away) from the palm, with the first knuckle (the metacarpophalangeal joint) positioned dorsally (on the back) at an angle between 45 and 90 degrees relative to the forearm. The tip of the thumb often points slightly towards the little finger. Additional “freedom of motion” as used in the present disclosure pertaining to a finger corresponds to a finger having its approximate normal range of motion (ROM) or at least near to its approximate normal ROM.

The term “executable actions” or instructions in the context of computing and software, refer to specific operations or tasks that a system, application, or device and associated processor is programmed to perform in response to certain inputs or commands. These actions are “executable” because they are carried out by executing a sequence of instructions or code and may include a wide range of actions.

In the context of computing and technology, “interaction” may refer to the communication or exchange of information between at least two entities, such as a user and a system, a user and a software application, or between different software applications or systems. This interaction may take various forms, such as a user-system interaction where a user provides input to a system and the system providing output in response (like displaying information on a screen, playing sound, providing haptic feedback, etc.). In the present disclosure, “interaction” refers to the process of a user providing input to the computing device via at least one ring input device and or tracker module and or voice input command, and the computing device responding by executing actions, in some implementations this may also mean providing output in the XR environment.

1. A system for interacting with a computing device, the system comprising:
a ring input device worn on a user's middle phalange, the ring input device having a touch-sensitive surface for receiving input from the user's thumb, without substantially bending the thumb;
the computing device operably coupled to the ring input device, the computing device further comprising at least one processor, in communication with a non-transitory memory device, storing thereon a set of executable instructions configured when executed by the at least one processor to execute actions corresponding to the input received from the ring input device; and
a virtual reality environment, an augmented reality environment, or a mixed reality environment, operationally configured to interact with the computing device and configured to execute actions corresponding to both ring input and a tracker module operationally configured to track index finger pointing.

2. The system of claim 1, wherein the ring input device is configured to allow freedom of movement of the user's index finger.

3. The system of claim 1, wherein the ring input device is operably coupled to the middle phalange of the user's middle finger.

4. The system of claim 1, wherein the ring input device having at least a portion comprised of an elastomeric material.

5. The system of claim 1, wherein the set of executable instructions is further configured, when executed by the at least one processor, to cause the computing device to execute actions corresponding to the input received from the ring input device, tracker module, or a combination thereof, the executable actions comprising at least one of: scrolling, zooming, selecting, grabbing, rotating, firing shots in a first-person shooter game, manipulating 3D content, interacting with virtual user interface (UI) elements, initiating a voice-based interaction, or any combination thereof.

6. The system of claim 5 comprising an additional ring input device and tracker module in communication with the computing device.

7. The system of claim 6, wherein the set of executable instructions is further configured, when executed by the at least one processor, to cause the computing device to execute input from the first ring input device, the first tracker module, the second ring input device, the second tracker module, or any combination thereof.

8. The system of claim 1, wherein the touch-sensitive surface of the ring input device is at least one of: a touchscreen, a scroll wheel, a button, or a combination thereof.

9. A method of interacting with a computing device using a ring input device, the method comprising:
wearing the ring input device on a user's middle phalange;
establishing an operable connection between the ring input device and the computing device;
receiving input from the user's thumb on a touch-sensitive surface disposed on the ring input device without substantially bending the thumb; and
transmitting the received input to the computing device for execution of corresponding actions.

10. The method of claim 9 further comprising a tracker module operationally configured to track the movement of at least one of the user's fingers and using the tracked finger movement as additional input for the computing device.

11. The method of claim 10, wherein the computing device is configured to receive input from both the touch-sensitive interface of the ring input device and tracker module simultaneously and in combination.

12. The method of claim 11, wherein the tracked finger has freedom of movement.

13. The method of claim 12, wherein the tracker module and computing device are operably coupled to an augmented reality, a virtual reality, or a mixed reality environment (XR).

14. The method of claim 13, wherein the received input from the ring input device and tracker module corresponds to executable actions and wherein the executable actions comprise at least one of: scrolling, clicking, selecting, moving a cursor, zooming, firing shots in a first-person shooter game, reloading in a first-person shooter game, manipulating 3-dimensional content, interacting with virtual UI elements, initiating a voice-based interaction, or any combination thereof.

15. The method of claim 14, wherein manipulating 3-dimensional content comprises at least one of: resizing, shaping, sculpting, repositioning, rotating, animating, grouping, duplicating, or combinations thereof.

16. A method for inputting distinct executable actions on the same hand of a user, implemented in a system comprising: at least one ring input device configured to be worn on the user's middle phalange and to receive input from the user's thumb on a touch-sensitive surface disposed on the ring input device, at least one tracker module configured to at least receive input from the user's index finger, at least one computing device, and an augmented reality, a virtual reality, or a mixed reality (XR) environment, operably connected thereof, and operably configured to receive the input and execute corresponding actions, the method comprising:
inputting an executable action by the thumb interacting with the touch-sensitive surface, or the index finger interacting with the tracker module, or combinations thereof;
receiving input from the ring input device, the tracker module, or combinations thereof;
executing a corresponding action on the at least one computing device, or XR environment, or combinations thereof.

17. The method of claim 16, wherein the ring input device is operationally configured to be worn on the middle phalange of the user's middle finger.

18. The method of claim 17, wherein the tracker module tracks and has a direct line of site to the user's index finger pointing while the thumb interacts with the touch-sensitive surface.

19. The method of claim 16, wherein corresponding actions comprise at least one of: scrolling, clicking, selecting, grabbing, holding, moving, moving a cursor, zooming, firing shots in a first-person shooter game, reloading in a first-person shooter game, manipulating 3-dimensional content, interacting with virtual UI elements, initiating a voice-based interaction, or any combination thereof.

20. The method of claim 19, comprising additional inputs from a second hand's second ring input device and a second tracker module, wherein additional executable actions correspond to the additional inputs from the first ring input device, the first tracker module, the second ring input device, the second tracker module, or combinations thereof.
